(19) United States
(12) Patent Application Publication
(10) Pub. No.: US 2016/0075600 A1
(43) Pub. Date: Mar. 17, 2016

(54) FAST CURING COMPOSITION FOR THE MANUFACTURE OF POLYURETHANE CEMENTITIOUS HYBRID FLOORING

(71) Applicant: SIKA TECHNOLOGY AG, Baar (CH)

(72) Inventors: Patricia GIMENO, Stuttgart (DE); Matthias NIETHAMMER, Sussen (DE); Jochen GRÖTZINGER, Schwäbisch Gmünd (DE); Carsten ZILG, Korntal-Münchingen (DE)

(73) Assignee: SIKA TECHNOLOGY AG, Baar, OT (CH)

(21) Appl. No.: 14/786,767

(22) PCT Filed: Apr. 25, 2014
(86) PCT No.: PCT/EP2014/058489

§ 371 Date: Oct. 23, 2015

(30) Foreign Application Priority Data
Apr. 26, 2013 (EP) 13165592.0

(51) Int. Cl. C04B 24/28; C04B 28/04; C04B 28/10

(52) U.S. Cl. CPC C04B 24/282; C04B 28/10; C04B 28/04

(57) ABSTRACT

The present application relates to a multi-component composition comprising a polyol component comprising one or more polyols and water, a polyisocyanate component comprising methylene diphenyl diisocyanate (MDI), a powder component comprising cement, calcium hydroxide and one or more aggregates and less than 0.5 wt.-%, based on the total weight of the polyol, polyisocyanate and the powder component, of a curing accelerator component comprising an amino alcohol and an acid. Polyurethane cementitious hybrid flooring or coating systems having an improved curing speed and enhanced aesthetic properties in that they show substantially no difference in colour shade can be achieved. Blister formation can be avoided.

### TECHNICAL FIELD

The invention relates to a multi-component composition for the manufacture of a polyurethane cementitious hybrid flooring or coating, a method for the manufacture of the flooring or coating with the multi-component composition and the flooring or coating obtainable by the method.

### BACKGROUND OF THE INVENTION

In the prior art, epoxy resin floors show satisfactory appearance, however these materials suffer from use limitations and involve the use of amines for their fabrication. Further limitations are imposed by the European Union REACH regulation which is concerned with chemical substances and will affect in particular amines required for epoxy chemistry. Thus, an alternative chemistry providing materials with similar properties is required.

Polyurethane (PU) cementitious hybrid systems are known for the preparation of coating and flooring products which have outstanding mechanical properties. However, such PU hybrid systems suffer from slow curing especially for the polyurethane formation reaction. It is often observed, that the reaction between the polyalcohols and polyisocyanates in these systems is not finished at temperatures of 20° C. or below even after 24 hours. Even though the values of compressive strength after this time are good enough to be exposed to traffic, the long “into service time” is a huge disadvantage for the available systems, because it is necessary to wait more than one day when the surrounding temperatures are less than 25° C.

Polyurethane cementitious hybrid systems are complex systems wherein during curing of the precursor components two main reactions occur, namely the reaction of polyols and polyisocyanates to form the polyurethane and the reaction of cement and water which is generally called hydration. Upon hydration, the cement hardens to a solid material. The hydration is usually effected in the presence of aggregates such as sand or gravel so that the aggregate particles are bound together by the cement material to obtain mortar or concrete.

Admixtures of amino alcohols and acids have been known in combination with cement materials as corrosion protectives. These materials are usually added to the cement in 3 to 4 wt.-% to effect corrosion protection for example in ferroconcrete applications. A known anti-corrosive agent commercialized for this purpose is e.g. FerroGard® 901 by Sika (Switzerland). This material is particularly suitable as a corrosion protective for rebars embedded in concrete.

Admixtures of amino alcohols and fatty acids in combination with ethoxylated alkyl phenols have also been described as dispersion stabilizers for isocyanate-reactive organic compound/water dispersions in EP 0 383 492 A2. These dispersions can be used to formulate polyurethane/cement hybrid systems and usually employ an amount of 0.5 to 20 parts of the stabilizer on 100 parts of the isocyanate-reactive organic compound. One disadvantage of the compositions of EP 0 383 492 A2 is however, that the surfaces prepared therewith exhibit a relatively high amounts of surface defects such as pinholes and blisters. This is a problem for applications, in which a smooth upper surface is required.

There remains a need for polyurethane cementitious hybrid systems which exhibit fast curing to provide hardened surfaces after 24 h when cured at temperatures of 20° C. or below, and at the same time provide a highly smooth surface without a considerable number of pinholes and blisters.

A further disadvantage with the available multi-component polyurethane cementitious hybrid systems is that even if all components are from the same batch, the application often leads to differences in the colour shade in the overlap range of two different packs. This is a huge aesthetical disadvantage.

There is therefore a need for a material which can ensure substantially identical colour shade for individual polyurethane cementitious hybrid systems being of the same composition when these systems are applied.

### SUMMARY OF THE INVENTION

The object of the present invention is to provide a fast curing multi-component composition for polyurethane cementitious hybrid systems which can cure at temperatures of 20° C. or lower within 24 h. The system should in addition have the properties of known polyurethane cementitious hybrid systems of the prior art.

Surprisingly, this object could be achieved by using a multi-component composition which includes a curing accelerator component comprising an amino alcohol and an acid in an amount of less than 0.5 wt.-% with respect to the combined weights of the polyol, polyisocyanate and powder components. Moreover, further improved results can be achieved when the polyol component, in particular the content of water contained therein, is adapted in an appropriate manner with respect to the content of the other ingredients in the composition.

Accordingly, the present application relates to a multi-component composition comprising
a polyol component comprising one or more polyols and water,
a polyisocyanate component comprising methylene diphenyl diisocyanate (MDI),
a powder component comprising cement, calcium hydroxide, and one or more aggregates, and
less than 0.5 wt.-%, based on the combined amounts of the polyol, polyisocyanate and powder component, of a curing accelerator component comprising an amino alcohol and an acid.

The inventive multi-component composition can be used as self-levelling or self smoothing screed or mortar and unexpectedly enables manufacture of polyurethane cementitious hybrid flooring systems which fully cure in about 24 h and do not show substantial differences in colour shade for different packs from the same batch with regard to all components in an overlap range. In addition, the characteristics as to workability, open time, mechanical properties such as in particular compressive strength, are outstanding and comparable to those of the prior art which lack the curing accelerator component.

The system of the invention is particularly suited as a polyurethane cementitious hybrid self-levelling screed with heavy duty demands for flooring, especially industrial flooring.

### DETAILED DESCRIPTION OF THE INVENTION

Substance names beginning with “poly” such as e.g. polyol or polyisocyanate, designate substances which formally contain, per molecule, two or more of the functional groups occurring in their names.

The term “open time” is understood to mean the duration of processability when the components are mixed with each other. The end of the open time is usually associated with viscosity increase of the composition such that processing of the composition is no longer possible.

The average molecular weight is understood to mean the number average molecular weight, as determined by gel permeation chromatography (GPC).

The multi-component composition of the invention comprises at least three individual components, which are stored separately in order to avoid spontaneous reaction, and are combined, when the polyurethane cementitious hybrid flooring or coating is to be prepared. The components may be assembled together as a package. Further, the components preferably comprise substantially all indicated ingredients of the multi-component composition, e.g. the polyisocyanate component comprises all polyisocyantes of the multi-component composition.

The components are a polyol component, a polyisocyanate component, a powder component and a curing accelerator component, which are described in the following.

### The Polyol Component

The polyol component comprises one or more polyols and water. Optionally, one or more additives may be added.

Examples of suitable polyols are polyoxyalkylenepolyols, also referred to as “polyetherpolyols”, polyesterpolyols, polycarbonatepolyols, poly(meth)acrylate polyols, polyhydrocarbon-polyols, polyhydroxy-functional acrylonitrile/butadiene copolymers and mixtures thereof, in particular diols thereof, and mixtures thereof.

Examples of polyetherpolyols are polyoxyethylenepolyols, polyoxypropylenepolyols and polyoxybutylenepolyols, in particular polyoxyethylenediols, polyoxypropylenediols, polyoxybutylenediols, polyoxyethylenetriols and polyoxypropylenetriols. Polyoxyalkylenediols or polyoxyalkylenetriols having a degree of unsaturation of less than 0.02 meq/g and having an average molecular weight in the range from 1000 to 30000 g/mol and polyoxyethylenediols, polyoxyethylenetriols, polyoxypropylenediols and polyoxypropylenetriols having an average molecular weight of from 400 to 8000 g/mol are appropriate.

Further examples of polyetherpolyols are so-called ethylene oxide-terminated (“EO-endcapped”, ethylene oxide-end-capped) polyoxypropylenepolyols, styrene-acrylonitrile-grafted polyetherpolyols, e.g. Lupranol® from Elastogran GmbH, Germany.

Particularly preferred polyols to be used in the present invention are polyhydroxy-functional fats and/or oils, for example natural fats and/or oils, such as castor oil, or polyols obtained by chemical modification of natural fats and/or oils, so-called oleochemical polyols. Castor oil is particularly preferred.

Examples of chemically modified natural fats and/or oils are polyols obtained from epoxypolyesters or epoxypolyethers obtained, for example, by epoxidation of unsaturated oils, by subsequent ring opening with carboxylic acids or alcohols, polyols obtained by hydroformylation and hydrogenation of unsaturated oils, or polyols which are obtained from natural fats and/or oils by degradation processes, such as alcoholysis or ozonolysis, and subsequent chemical linkage, for example by transesterification or dimerization, of the degradation products thus obtained or derivatives thereof. Suitable degradation products of natural fats and/or oils are in particular fatty acids and fatty alcohols and fatty acid esters, in particular the methyl esters (FAME), which can be derivatized, for example, by hydroformylation and hydrogenation to give hydroxy-fatty acid esters.

The polyols mentioned above usually have a relatively high molecular weight, for instance, an average molecular weight of from 250 to 30000 g/mol, in particular from 1000 to 30000 g/mol, and/or an average OH-functionality in the range from 1.6 to 3.

Further examples of suitable polyols are low molecular weight di- or polyhydric alcohols, e.g., with a molecular weight of less than 250 g/mol. Examples thereof are 1,2-ethanediol, 1,2- and 1,3-propanediol, neopentylglycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols, such as xylitol, sorbitol or mannitol, sugars, such as sucrose, other alcohols having a higher functionality, low molecular weight alkoxylation products of the abovementioned di- and polyhydric alcohols, and mixtures thereof.

While said low molecular weight di- or polyhydric alcohols may be used as the polyol, the use of the polyols mentioned above having a high molecular weight is preferred. In a preferred embodiment at least one of the polyols of high molecular weight mentioned above and at least one low molecular weight di- or polyhydric alcohol are used in combination. Particularly preferred is a combination of one or more polyhydroxy-functional fats and oils, such natural fats and oils, or polyols obtained by chemical modification of natural fats and oils, in particular castor oil, and one, two or more low molecular weight di- or polyhydric alcohols. In such combinations, the one or more polyols having a high molecular weight are usually used in higher amounts than the at least one low molecular weight di- or polyhydric alcohol.

As concerns the amount of the low molecular weight di- or polyhydric alcohols in the polyol component, it is preferred that this is in the range of 0 to 7 wt.-%, based on the total weight of the polyol component. Accordingly, the multi-component composition of the present application may be formulated without low molecular weight di- or polyhydric alcohols. It has been found however, that the addition of this component allows superior fine tuning of the final product properties, so that it is preferred if one ore more low molecular weight di- or polyhydric alcohols are present in the composition. More preferably, the amount of low molecular weight di- or polyhydric alcohols is in the range of 1 to 5 wt.-% and most preferably the amount is about 5 wt.-%.

Apart from the one or more polyols and water, the polyol component may contain further additives. Such additives are commonly used, if desired, and typically known to the persons skilled in the art of polyurethanes. Examples of optional additives are plasticizers, pigments, adhesion promoters, such as silanes, e.g. epoxysilanes, (meth)acrylatosilanes and alkylsilanes, stabilizers against heat light and UV radiation, thixotropic agents, flow improving additives, flame retardants, surface active agents such as defoamers, wetting agents, flow control agents, deaerating agents, and biocides.

Preferably used optional additives for the polyol component are one or more of plasticizers, such as benzoates, phthalates, or diisopropylbenzen (usually a mixture of isomers), inorganic and organic pigments, defoamers, such as silicon free solvents and organo-modified polysiloxanes and emulsifiers such as calcium hydroxide.

### The Polyisocyanate Component

The polyisocyanate component comprises methylene diphenyl diisocyanate. In the following, methylene diphenyl diisocyanate is abbreviated as MDI as usual. MDI is a useful compound, e.g. as a starting material for polyurethane production, and produced worldwide in millions of tons annually. A plurality of different product grades of MDI is available. “Methylene diphenyl diisocyanate” as this term is used in the present invention, includes, depending on its grade, monomeric, oligomeric and polymeric MDI. The term in the context of the polyisocyante component encompasses all of these components in the polyisocyanate component.

MDI is available in the form of three different isomers, namely 4,4′-methylene diphenyl diisocyanate (4,4′-MDI), 2,4′-methylene diphenyl diisocyanate (2,4′-MDI), and 2,2′-methylene diphenyl diisocyanate (2,2′-MDI). Commercially available MDI can be classified into monomeric MDI (also designated MMDI) and polymeric MDI (PMDI) also referred to as technical MDI. Polymeric MDI is the raw product of MDI synthesis containing MDI isomers and oligomeric species. Monomeric MDI is obtained from polymeric MDI by purification.

Monomeric MDI refers to “pure” MDI including products of a single MDI isomer or of isomer mixtures of two or three MDI isomers. The isomeric ratio can vary in wide ranges. For instance, 4,4′-MDI is a colorless to yellowish solid having a melting point of 39.5° C. Commercial monomeric MDI is often a mixture of 4,4′-MDI, 2,4′-MDI and typically very low levels of 2,2′-MDI.

Polymeric MDI includes oligomeric species in addition to MDI isomers. Thus, polymeric MDI contains a single MDI isomer or isomer mixtures of two or three MDI isomers, the balance being oligomeric species. Polymeric MDI tends to have isocyanate functionalities of higher than 2. The isomeric ratio as well as the amount of oligomeric species can vary in wide ranges in these products. For instance, polymeric MDI may typically contain about 30 to 80 wt.-% of MDI isomers, the balance being said oligomeric species. As in the case of monomeric MDI, the MDI isomers are often a mixture of 4,4′-MDI, 2,4′-MDI and very low levels of 2,2′-MDI. Polymeric MDI is typically a brown or dark amber liquid at room temperature (23° C.).

The oligomeric species are oligomers having a NCO functionality of 3 or higher. The oligomeric species are a result of the synthesis process and can be represented by the following formula

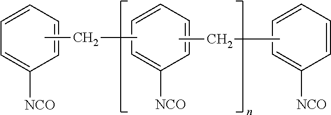

wherein n is 1 to 4 and higher. The amount of the homologues decreases with increasing chain length. The total content of homologues with n higher than 4 is generally not very high.

A wide variety of polymeric MDI grades is available with varying characteristics as to the number, type and content of isomers and oligomeric species, isomeric ratio, and weight distribution of the oligomeric homologues. These characteristics depend on type and conditions of synthesis and purification procedures. Moreover, the characteristics can be adjusted, e.g., by mixing different MDI grades according to the needs of the customer.

According to the present invention, in the MDI used at least 40 wt.-%, and preferably at least 45 wt.-% of the MDI isomers are 4,4′-MDI.

With regard to 2,4′-MDI present in the polyisocyanate component, it is preferred that this is present in amounts of less than 30 wt.-% and preferably less than 25 wt.-% of the whole polyisocyanate component. Moreover, it is preferred, that the polyisocyanate component comprises 2,4′-MDI and 4,4′-MDI in a ratio of 10:90 to 40:60.

The ratio of 2,4′-MDI and 4,4′-MDI has an impact on the potlife of the multi-component composition. In higher temperature environments such as for example at 20 to 35° C., the polyisocyanate reaction is faster so that it is necessary to employ a lower content of 2,4′-MDI isomers to obtain similar potlife. For such climates, it is thus preferred that the 2,4′-MDI content in the composition is in the range of 4 to 12 wt.-%, preferably 5 to 10 wt.-% based on the total weight of the polyisocyanate composition. For such climates, it is further preferred that the ratio of 2,4′-MDI/4,4′-MDI is 10-20:90-80. For regular working temperatures of 5 to 20° C. found e.g. in northern European climates, it is necessary that the 2,4′-MDI content is higher ensuring faster reaction at low temperatures. For such applications, the content of 2,4′-MDI is preferably in the range of 10 to 30 wt.-%, more preferably 15 to 25 wt.-% based on the total weight of the polyisocyanate component. Likewise, the ratio of 2,4′-MDI vs. 4,4′-MDI is preferably higher for such applications such as in particular 20-40:80-60, preferably 25-35:65-75.

The polyisocyanate component may optionally comprise one or more further additives such as solvents in relatively small amounts, e.g. up to 10 wt.-% of the additives all together, preferably up to 5 wt.-% and more preferably up to 2 wt.-% based on the total weight of the polyisocyanate component. Suitable solvents for addition to the polyisocyanate compound include but are not limited to esters, ketones, hydrocarbons and chlorinated hydrocarbons. It is generally preferred however that the polyisocyanate component consists of MDI, i.e. monomeric MDI and/or polymeric MDI. Since the MDI products are technical products, they may, of course, include low quantities of impurities.

### The Powder Component

The powder component comprises cement, calcium hydroxide and/or calcium oxide, and one or more aggregates.

As the cement, any conventional cement type or a mixture of two or more conventional cement types may be used, for example, cements classified according to DIN EN 197-1: Portland cement (CEM I), Portland composite cement (CEM II), blast furnace cement (CEM III), pozzolanic cement (CEM IV) and composite cement (CEM V). These main types are divided into 27 subtypes, known to those skilled in the art. Of course, cements produced in accordance with another standard, such as according to ASTM Standard or Indian Standard are also suitable.

Portland cement is the most common type of cement and appropriate for the present application. This cement is in general in use around the world, because it is a basic ingredient of concrete, mortar, stucko and most non-specialty grout. It is a fine powder produced by grinding Portland cement clinker (more than 90%) with a limited amount of calcium sulphate which controls the set time, and up to 5% minor constituents as defined by the European standard EN 197.1.

A preferred cement is white cement, such a white cement I-52:5 and I-42,5R. White cement is a Portland cement with a low iron oxide content. It is similar to ordinary, gray Portland cement except for its high degree of whiteness.

The powder component further comprises calcium hydroxide, also known as hydrated lime, and/or calcium oxide. This material can be purchased as a white powder. Calcium hydroxide, respectively calcium oxide plays an important role in the composition by controlling the workability and avoiding blister formation from CO₂ produced in the reaction of isocyanate with water from the polyol component.

In addition, the powder component comprises one or more aggregates. Aggregates are chemically inert, solid particulate materials and come in various shapes, sizes, and materials ranging from fine particles of sand to large, coarse rocks. Examples of particularly suitable aggregates are sand, gravel, and crushed stone, slag, calcined flint, and lightweight aggregates such as clay, pumice, perlite, and vermiculite. Sand, in particular silica sand, is preferably used to adjust the workability required to obtain a smooth surface.

The grain size of the aggregates is preferably rather small, e.g. less than 5 mm. The aggregate may have, for example, a grain size in the range of 2 mm to 0.05 mm, wherein sand, in particular silica sand, having a grain size in the range of 0.1 to 1 mm is particularly preferred. For instance, sand having a grain size ranging from 0.3 to 0.8 mm or from 0.1 to 0.5 mm or combinations thereof can be advantageously used in the present invention. The grain size range can be determined, e.g. by sieve analysis.

The powder component may additionally comprise one or more additives which are commonly used, if desired, and typically known to the persons skilled in the art of cement applications. Examples of suitable additives, which may be optionally used in the powder component, are superplastizicers, preferably based on polycarboxylate ethers, mineral oil, castor oil, and inorganic or organic pigments.

The amount of additives in the powder component preferably does not exceed 10 wt.-%, based on the total weight of the powder component, more preferably the amount of additives is 5 wt.-% or less and even more preferably the amount is 2 wt.-% or less.

### The Curing Accelerator Component

As stated above, the curing accelerator component comprises an amino alcohol and an acid and is added to the composition in amounts of less than 0.5 wt.-% of the combined amount of the polyol, polyisocyanate and powder component. The curing accelerator component can be provided in form of a component, which is physically separated from the other components, or the curing accelerator can be added directly to the polyol component, provided the component is uncreative towards the ingredients of the curing accelerator component. In the practice of the present application, it is preferred however to provide the curing accelerator as a separate component, as this allows to adjust its amount to be added depending on the temperature conditions at the site of application.

With regard to the acid, the present application is not significantly limited, it is preferred however that the acid is a weak acid, i.e., an acid having a pKa of 3.5 or more. Even though, the acid can be an inorganic or an organic acid. A preferred inorganic acid for use in the present application is boric acid. Preferred organic acids are aromatic acids such as e.g. benzoic acid. Since boric acid has not been registered with REACH, the use of aromatic acids is particularly preferred in the practice of the present invention.

The amino alcohol is preferably an alkyl amino alcohol, more preferably an alkyl amino alcohol having 1 to 6 carbon atoms in the alkyl group. Preferred examples of such alkyl amino alcohols are monoethanolamine (MEA), diethanolamine (DEA), triethanolamine (TEA), dimethylethanolamine (DMEA), N-methyl-diethanolamine (MDEA), Diethylethanolamine (DEEA), and ethyldiethanolamine (EDEA).

In addition to the afore-mentioned components, the curing accelerator component may further comprise a plasticiser for cementitious materials. Plasticisers for cementitious materials are well-known in the art and include sulphonated melamine formaldehyde resins, sulphonated melamine urea formaldehyde resins and polycarboxylate polymers. Preferred plasticisers for use in the present application are sulphonated melamine resins and/or polycarboxylated polymers, in particular polycarboxylated graft polymers having carboxyl functional groups in the backbone and pendant non-charged polymeric chains grafted to the backbone. Respective plasticizers are available e.g. From Sika (Switzerland) under the trade names Viscocrete® and Sikament® FF 86.

The curing accelerator component of the present application on the other hand is preferable substantially free from ethoxylated alkyl phenol additives, which have been described for use with amino alcohols and fatty acids as dispersion stabilizers of isocyanate reactive polyols. Accordingly, the curing accelerator component preferably comprises not more than 5 wt.-%, more preferably not more than 2 wt.-% and most preferably no added ethoxylated alkyl phenols. The indicated wt.-percentage is relative to the total weight of the curing accelerator component.

The amount of curing accelerator necessary to ensure sufficient acceleration of cure can be adjusted to the needs of the application. It is preferred however, that the content of the curing accelerator component in the composition is 0.25wt.-% or less, in particular 0.1 wt.-% or less, based on the total weight of the polyol, polyisocyanate and the powder component. A highly preferred content of the curing accelerator component is in the range of from 0.005 to 0.025 wt.-%, especially 0.01 to 0.015 wt.-% based on the total weight of the polyol, polyisocyanate and the powder component. If the amount of additive component is less than 0.005 wt.-%, it cannot be ensured that the material is fully cured at temperatures of 20° C. or less after 24 h. If on the other hand the percentage of the additive component is in excess of 0.025 wt.-%, this leads to an undesirable reduction of the open time of the product and the observation of pigment flotation.

### Suitable Proportions for the Polyol, Polyisocyanate and Powder Component in the Multi-Component Composition

By adjusting the proportions of the ingredients within the components and between the components in a suitable manner, the improvements of the present invention can be significantly enhanced. Such suitable proportions are described in the following. The ingredients indicated refer to the ingredients in the particular component as discussed above. Ratios referring to ingredients in different components relate to correct proportions of each component according to the operating instructions, i.e. to the mixing ratio to be used for mixing the components and, in use to the mixture of the components prepared.

In a preferred embodiment, the polyol component, the polyisocyanate component and the powder component account for 10 to 25 wt.-%, 10 to 25 wt.-% and 50 to 80 wt.-%, respectively, of the combined amount of the polyol, polyisocyanate, and powder components.

As to the mixing ratio of the polyol, polyisocyanate and powder component, the weight ratio of the polyol component to the polyisocyanate component is preferably in the range of 40:60 to 60:40, and more preferably in the range of about 50:50.

The weight ratio of the combined polyol and polyisocyanate components to the powder component is preferably in the range of 1:1 to 1:5, more preferably in the range of 1:2 to 1:3. Said mixing ratios are particularly preferred, if the polyol component, the polyisocyanate component and the powder component are formulated according to the proportions outlined above.

The multi-component composition of the invention is further preferably formulated such that the content of water is in the range of 4.5 to 6.5 wt.-%, the content of the MDI is in a range of from 15 to 17 wt.-% and the content of cement is in the range of 16 to 25 wt.-%, based on the total weight of the polyol, polyisocyanate and the powder component.

Differences in the amount of water can influence not only the finished surface of the product, but also the physical properties such as compression strength, workability and open time. Therefore, the proportion of water with respect to the other ingredients is to be determined carefully.

The amount of water in the polyol component is preferably in the range of from 10 to 50 wt.-%, more preferably in the range of from 20 to 40 wt.-% and most preferably in the range of from 25 to 30 wt.-%. It is further preferred that the amount of water with regard to the combined amounts of the polyol, polyisocyanate and powder component is in the range of 4.5 to 6.5 wt.-%.

In the powder component, the calcium hydroxide (hydrated lime) or calcium oxide plays an important role. The absence of calcium hydroxide would lead to the formation of big bubbles on the cured products surface due to the formation of CO₂ by the reaction of the polyisocyanate compound and water present in the polyol component. On the other hand, too high amounts of calcium hydroxide have an unfavourable impact on the workability of the system. A preferred amount of calcium hydroxide in the powder component is thus in the range of from 2 to 8 wt.-%, preferably 4.5 to 6 wt.-% based on the total weight of the powder component. Calcium oxide on hydration forms calcium hydroxide and thus serves the same purpose as the calcium hydroxide.

With regard to the total multi-component composition, a preferred content of calcium hydroxide is 1.4 to 5.6 wt.-%, preferably 3.1 to 4.2 wt.-% based on the combined amounts of the polyol, polyisocyanate and powder component.

The ratio of water to calcium hydroxide in the multi component composition is generally in the range of 0.80 to 4.6:1 preferably in the range of from 1.5 to 3.5:1.

The molar ratio of the NCO groups to alcoholic OH groups in the multi-component composition is preferably in the range of from 1.5:1 to 3:1, more preferably in the range of from 2:1 to 2.5:1. Such molar ratio leads to an improvement of the compressive strength of the finished product.

The polyol component is preferably formulated such that the polyol content is in the range of 20 to 60 wt.-%, preferably 30 to 50 wt.-%, and in particular 32 to 43 wt.-%, based on the total weight of the polyol component.

The powder component is preferably formulated such that at least one of the following conditions is fulfilled, each based on the total weight of the powder component:

a) the cement content is in the range of 8 to 45 wt.-%, preferably 26 to 30 wt.-%,

b) the calcium hydroxide content is in the range of 2 to 8 wt.-%, preferably 4.5 to 6 wt.-%,

c) the aggregates content, preferably sand, is in the range of 50 to 90 wt.-%, preferably 60 to 80 wt.-%.

In a preferred embodiment, both the polyol component and the powder component are formulated according to the proportions outlined above. Moreover, it is preferred that the polyisocyanate component consists of MDI.

### Use of an Acid/Aminoalcohol Mixture as a Curing Accelerator

A further aspect of the present application is directed to the use of an admixture of an amino alcohol and an acid to increase the curing speed of a composition comprising one or more polyols, MDI, cement, aggregates, calcium hydroxide and/or calcium oxide, and water. In a preferred embodiment of this use, the admixture of the amino alcohol and the acid is added to the composition comprising one or more polyols, MDI, cement, aggregates, calcium hydroxide and/or calcium oxide, and water in an amount of less than 0.5 wt.-%, in particular in an amount of from 0.005 to 0.05 wt.-%, and more preferably 0.01 to 0.025 wt.-%, and even more preferably 0.01 to 0.015 wt.-%. An amount of the admixture of 0.01 to 0.015 wt.-% is particularly preferred, if the admixture is provided as a combination with polyol component or if the application temperature of the composition in the range of 20 to 35° C. and the admixture is provided as a fourth component. If the application temperature of the composition in the range 15 to 20° C., the amount of the admixture is preferably higher, namely in the range of 0.01 to 0.03 wt.-%, while at application temperatures of below 15° C. the preferred amount of the admixture is in the range of 0.03 to 0.05 wt %. Further preferred embodiments of this use are the same as mentioned above for the multi-component composition.

### Method for the Manufacture of a Polyurethane Cementitious Hybrid Flooring or Coating

The multi-component composition of the invention is suitable to prepare a polyurethane cementitious hybrid flooring or coating. The method comprises
mixing the polyol component and the polyisocyanate component,
adding the powder component and the curing accelerator component to the mixture of polyol component and the polyisocyanate component and agitating the same to obtain a substantially homogeneous mixture
applying the substantially homogeneous mixture to a substrate, and
curing the applied mixture to obtain the cementious flooring or coating.

A typical layer thickness e.g. ranges from 2 to 6 mm. The application temperature is preferably from about 8 to 35° C. Fast curing in less than 24 h for a wide range of temperatures can be achieved. Application of a top sealer is not required so that one day application is possible. “Substantially” in the above context means, that the compositions appears to be homogeneous to the human eye.

The multi-component composition is suitable as a self-levelling system or screed. The method provides flooring and coating systems which can be sufficiently cured within 24 h even at temperatures of below 20° C. and which have no differences in the colour shade for two different packs being from the same batch of all components in the overlap range.

The invention is further explained in the following experimental part which, however shall not be construed as limiting the scope of the invention. The proportions and percentages indicated are by weight, unless otherwise stated.

### Examples

The ingredients indicated in Table 1 below are mixed to form the polyol component, or the polyisocyanate component and the powder component. The amounts given are in parts by weight. For application, the components were mixed in a weight ratio of 14.3:14.3:71.4, respectively, as shown in Table 1. The last column shows the percentage portion by weight of each ingredient, based on the total weight of the three components.

The composition of MDI used is as follows: 22 wt.-% of 2,4′-MDI, 50% of 4,4′-MDI (by weight) the balance being oligomeric species.

TABLE 1

| | Com- | Com- | Com- | | |
|---|---|---|---|---|---|
| | ponent | ponent | ponent | Ratio | A + B + C |
| | A | B | C | A:B:C | (%) |
| Component A | 100 | | | 14.3 | |
| Component B | | 100 | | 14.3 | |
| Component C | | | 100 | 71.4 | |
| castor oil | 32-43 | | | | 4.8-6.45 |
| LV-117 | | | | | |
| plasticizer | 17-20 | | | | 2.6-3 |
| defoamer | 0.4-2 | | | | 0.3-0.6 |
| pigment | 0.6-4 | | | | 0.6-0.9 |
| water | 25-30 | | | | 3.75-4.5 |
| MDI | | 100 | | | 14-15 |
| silica sand, | | | 35 | | 24.5 |
| 0.3-0.8 mm | | | | | |
| silica sand, | | | 35 | | 23.8 |
| 0.1-0.5 mm | | | | | |
| hydrated lime | | | 4.5-6 | | 3.2-4.2 |
| white cement | | | 26-30 | | 18.2-21 |
| CEM | | | | | |

The above three component mixtures were formulated with different amounts of FerroGard® 901 containing an alkyl amino alcohol, boric acid, a plasticizer (Sikament® FF86) and water. The amount of Ferrogard added was from 0.005 to 0.025 wt.-% with regard to the total amount of the polyol, polyisocyanate and powder component. In a second set of experiments, the boric acid in Ferrogard 901 was replaced by benzoic acid.

The curing accelerator was mixed with the other three components to obtain a homogeneous mixture and hardened at 8° C., 20° C. and 35° C., respectively. The results of the investigations with boric acid are shown in the following tables 2 through 4.

TABLE 2

| | % Ferrogard 901/(A + B + C) | | | | | | | | | | | | | | |
|---|---|---|---|---|---|---|---|---|---|---|---|---|---|---|---|
| | 0.005% | | | 0.01% | | | 0.015% | | | 0.02% | | | 0.025% | | |
| | 1 | 2 | 3 | 1 | 2 | 3 | 1 | 2 | 3 | 1 | 2 | 3 | 1 | 2 | 3 |
| Workability/Ease of placement | [symbol] | □ | □ | [symbol] | □ | □ | [symbol] | □ | □ | □ | [symbol] | □ | □ | [symbol] | □ |
| Pot life at 8° C. | [symbol] | □ | □ | [symbol] | □ | □ | [symbol] | □ | □ | [symbol] | □ | □ | [symbol] | □ | □ |
| Forming of blisters | [symbol] | □ | □ | [symbol] | □ | □ | [symbol] | □ | □ | [symbol] | □ | □ | [symbol] | □ | □ |
| Forming of pinholes | [symbol] | □ | □ | [symbol] | □ | □ | [symbol] | □ | □ | [symbol] | □ | □ | □ | [symbol] | □ |
| Homogeneity of colour shade | [symbol] | □ | □ | [symbol] | □ | □ | [symbol] | □ | □ | [symbol] | □ | □ | [symbol] | □ | □ |
| Curing at 8° C. after 24 h | □ | □ | [symbol] | [symbol] | □ | □ | [symbol] | □ | □ | [symbol] | □ | □ | [symbol] | □ | □ |

TABLE 3

| | % Ferrogard 901/(A + B + C) | | | | | | | | | | | | | | |
|---|---|---|---|---|---|---|---|---|---|---|---|---|---|---|---|
| | 0.005% | | | 0.01% | | | 0.015% | | | 0.02% | | | 0.025% | | |
| | 1 | 2 | 3 | 1 | 2 | 3 | 1 | 2 | 3 | 1 | 2 | 3 | 1 | 2 | 3 |
| Workability/Ease of placement | [symbol] | □ | □ | [symbol] | □ | □ | [symbol] | □ | □ | [symbol] | □ | □ | [symbol] | □ | □ |
| Pot life at 23° C. | [symbol] | □ | □ | [symbol] | □ | □ | [symbol] | □ | □ | □ | [symbol] | □ | □ | [symbol] | □ |
| Forming of blisters | [symbol] | □ | □ | [symbol] | □ | □ | [symbol] | □ | □ | [symbol] | □ | □ | [symbol] | □ | □ |
| Forming of pinholes | [symbol] | □ | □ | [symbol] | □ | □ | [symbol] | □ | □ | [symbol] | □ | □ | [symbol] | □ | □ |
| Homogeneity of colour shade | [symbol] | □ | □ | [symbol] | □ | □ | [symbol] | □ | □ | [symbol] | □ | □ | [symbol] | □ | □ |
| Curing at 23° C. after 24 h | □ | □ | [symbol] | [symbol] | □ | □ | [symbol] | □ | □ | [symbol] | □ | □ | [symbol] | □ | □ |

TABLE 4

| | % Ferrogard 901/(A + B + C) | | | | | | | | | | | | | | |
|---|---|---|---|---|---|---|---|---|---|---|---|---|---|---|---|
| | 0.005% | | | 0.01% | | | 0.015% | | | 0.02% | | | 0.025% | | |
| | 1 | 2 | 3 | 1 | 2 | 3 | 1 | 2 | 3 | 1 | 2 | 3 | 1 | 2 | 3 |
| Workability/Ease of placement | [symbol] | □ | □ | [symbol] | □ | □ | [symbol] | □ | □ | [symbol] | □ | □ | [symbol] | □ | □ |
| Pot life at 35° C. | [symbol] | □ | □ | [symbol] | □ | □ | [symbol] | □ | □ | □ | [symbol] | □ | □ | [symbol] | □ |
| Forming of blisters | [symbol] | □ | □ | [symbol] | □ | □ | [symbol] | □ | □ | [symbol] | □ | □ | [symbol] | □ | □ |
| Forming of pinholes | [symbol] | □ | □ | [symbol] | □ | □ | [symbol] | □ | □ | □ | □ | [symbol] | □ | □ | [symbol] |
| Homogeneity of colour shade | [symbol] | □ | □ | [symbol] | □ | □ | [symbol] | □ | □ | [symbol] | □ | □ | [symbol] | □ | □ |
| Curing at 35° C. after 24 h | [symbol] | □ | □ | [symbol] | □ | □ | [symbol] | □ | □ | [symbol] | □ | □ | [symbol] | □ | □ |

In the above Tables “1” designated the best, while “3” designates the worst result.

The blistering test in the above tables was performed as follows: A wooden board of 0.3×0.26 m was primed with Sikafloor® 161 and fitted with a wooden frame of 5 mm height. The separate components and the wooden board were stored at 8° C., 23° C. and 35° C. for 16-24 h. Then, 1 kg of the material was mixed for 3 min at 900 rpm and applied on the primed board to obtain a layer of 4 mm thickness. The surface was spike-rolled and the board was placed back in an environment at 8° C., 23° C. and 35° C. and cured. After curing, the surface was evaluated for cracks and blisters.

As can be seen from the above tables, all compositions cure and form satisfying coatings under the reaction conditions. The results with FerroGard® 901 addition in the range of 0.01 to 0.015 wt.-% were in total better than those with less or more additive. When a lower amount of additive was used, the cure was not completed after 24 h while amounts of 0.020 wt.-% or more led to less favourable workability of the product and in some cases also to the formation of pinholes. At 23° C., compositions with 0.020 wt.-% of curing accelerator performed less suitable in terms of their potlife. For the curing at 35° C. an amount of curing accelerator in the range of 0.005 wt.-% and 0.015 wt.-% provided the best results. When the amount of additive was increased over 0.015 wt.-%, the potlife was less favourable and also some pinholes were observed.

Further properties of the materials in Tables 2 to 4 are presented in the following Table 5. The properties in this Table were determined as follows:

The flowability/workability was determined at the indicated temperature at 50% relative humidity using the cone described in DIN 1015-3, but without tamping the material. For the determination, 1 kg of material (at the indicated temperature, 50% relative humidity) was mixed for 3 min at 900 rpm. The cone was set on the glass sheet, filled to the rim, lifted and the diameter of the resulting circle was determined after 10 min

### Pot Life

1 kg of the material was mixed for 3 h at 900 rpm and applied in 6 mm thickness in a plastic lid of 25 cm diameter and after certain times, the diameter was scratched with a pallet knife. The longest time at which the mark still heals itself was taken as the pot life.

### Compressive Strength

Samples of 4×4×16 cm were prepared by filling moulds with the respective materials. The samples were then taken out of the moulds after 24 h and the test was carried out in line with EN 13892-2 (DIN EN 196-1) after 1 d, 7 d and 28 d of curing at 8° C., respectively 23° C., at 50% relative humidity. The increase of load for the compressive strength is 2400±200 N/s. The value presented for the compressive strength in table 5 is the mean of six individual measurements.

### Shore Hardness

Samples of 4.5 mm thickness were cast and cured at the respective temperatures (8° C., 23° C./50% relative humidity and 35° C.). The hardness measurement was done with a shore D durometer with automatic gauge at 3 s and 15 s. The distance between the measuring points was at least 13 mm apart from the edge of the test specimen. The scale was read in accordance with DIN EN ISO 868 after 3 s and 15 s, respectively. Three measurements were taken at different times over 28 d and the mean of these measurements is shown in Table 5.

TABLE 5

| % Ferrogard/A + B + C | 0% | 0.005-0.010% | 0.015% | 0.020-0.025% |
|---|---|---|---|---|
| Application T | | | | |
| Lower limit | 8° C. | 8° C. | 8° C. | 8° C. |
| Upper limit | 35° C. | 35° C. | 35° C. | 35° C. |
| Flowability/ | | | | |
| Workability | | | | |
| 8° C. | 275 mm-290 mm | 275 mm-290 mm | 275 mm-285 mm | 265 mm-275 mm |
| 23° C. | 305 mm-335 mm | 305 mm-335 mm | 305 mm-330 mm | 300 mm-325 mm |
| 35° C. | 305 mm-335 mm | 305 mm-335 mm | 310 mm-335 mm | 305 mm-325 mm |
| Pot life | | | | |
| 8° C. | >40 min | >40 min | >40 min | >40 min |
| 23° C. | 26 min | 26 min | 24 min | 22 min |
| 35° C. | 18 min | 16 min | 15 min | 12 min |
| Compressive | | | | |
| strength 8° C. | | | | |
| 1 d | 0 N/mm² | 0 N/mm² | 1-2 N/mm² | 1-2 N/mm² |
| 7 d | 35-38 N/mm² | 35-38 N/mm² | 45-48 N/mm² | 45-48 N/mm² |
| 28 d | 48-52 N/mm² | 48-52 N/mm² | 50-52 N/mm² | 50-52 N/mm² |
| Compressive | | | | |
| strength 23° C. | | | | |
| 1 d | 30-35 N/mm² | 30-35 N/mm² | 35-38 N/mm² | 35-38 N/mm² |
| 7 d | 45-48 N/mm² | 45-48 N/mm² | 50-52 N/mm² | 50-52 N/mm² |
| 28 d | 50-52 N/mm² | 50-52 N/mm² | 55-60 N/mm² | 55-60 N/mm² |
| Hardness Shore D | | | | |
| 8° C. | | | | |
| 17h | 2 | 3 | 10 | 14 |
| 24h | 5 | 18 | 28 | 29 |
| 48h | 10 | 53 | 60 | 65 |
| 7 d | 78 | 79 | 78 | 81 |
| 28 d | 82 | 82 | 81 | 82 |
| Hardness Shore D | | | | |
| 23° C. | | | | |
| 17h | 61 | 66 | 69 | 73 |
| 24h | 71 | 72 | 75 | 78 |
| 48h | 79 | 79 | 79 | 80 |
| 28 d | 82 | 82 | 83 | 83 |

### Example 2

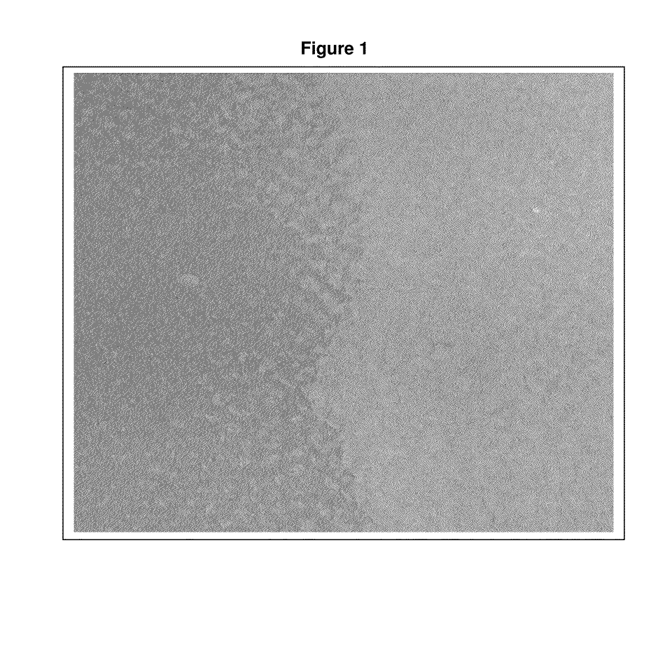

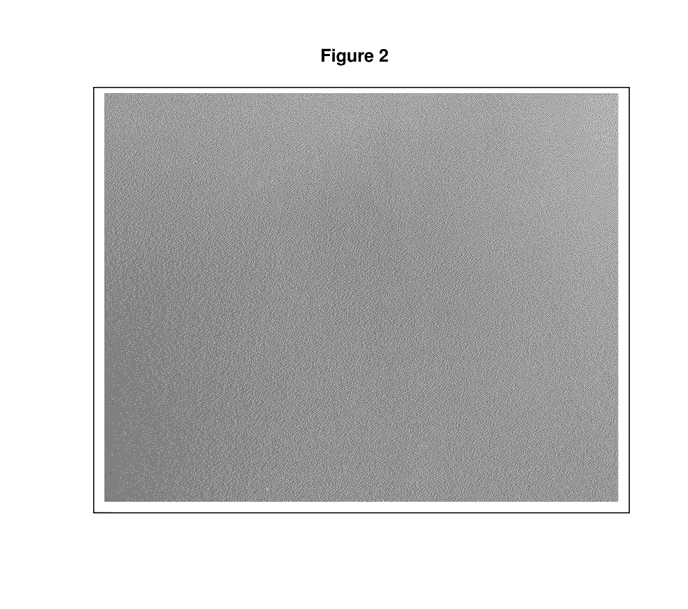

To investigate whether differences in the colour shade during application of two different packs of the same material comprising the same batch of all components could be reduced, two packs of polyol, polyisocyanate and powder component were admixed either with or without 0.01 wt.-% of FerroGard® 901 and applied next to each other on a patch of 2 m². The results of these investigations are shown in FIGS. 1 and 2. FIG. 1 is the Sample without FerroGrad® whereas FIG. 2 shows the ample with 0.01 wt.-% FerroGrad®. As can be observed from the figures, the surface finish was improved and differences in colour shade between the two packs were almost not visible with the Sample containing FerroGard® additive. The regular sample without FerroGrad® in contrast showed visible colour shade differences.

1. A multi-component composition comprising
a polyol component comprising one or more polyols and water,
a polyisocyanate component comprising methylene diphenyl diisocyanate (MDI),
a powder component comprising cement, calcium hydroxide, and one or more aggregates, and
less than 0.5 wt.-%, based on the total amount of the polyol, polyisocyanate and powder component of an curing accelerator component comprising an amino alcohol and an acid.

2. The multi-component composition of claim 1, wherein the curing accelerator component comprises an alkylamino alcohol and an acid having a pKa of 3.5 or more, preferably boric acid or benzoic acid.

3. The multi-component composition of claim 1, wherein the additive component further comprises a plasticizer for cementitious materials, preferably based on sulfonated melamine and/or a polycarboxylate ether polymer.

4. The multi-component composition of claim 1, wherein the content of curing accelerator component in the composition is 0.005 to 0.05 wt.-%, preferably 0.01 to 0.015 wt.-%, based on the total weight of the polyol, polyisocyanate and the powder component, and wherein the curing accelerator is preferably provided in admixture with the polyol component.

5. The multi-component composition of claim 1, wherein the curing accelerator is separate from the polyol, polyisocyanate and powder component and is present in an amount of from 0.005 to 0.05 wt.-%, more preferably 0.01 to 0.015 wt.-%, 0.01 to 0.03 wt.-% or 0.03 to 0.05 wt %.

6. The multi-component composition according to claim 1, wherein the at least one polyol comprises a polyhydroxy-functional fat or oil and/or a polyol obtained by chemical modification of a natural fat or oil, preferably wherein the polyol comprises castor oil.

7. The multi-component composition according to claim 1, wherein water accounts for 10 to 50 wt.-% of the polyol component.

8. The multi-component composition according to claim 1, wherein the polyisocyanate component comprises 2,4′-MDI and 4,4′-MDI in a ratio of 10:90 to 40:60.

9. The multi-component composition according to claim 1, wherein the powder component comprises 2 to 8 wt.-%, preferably 4.5 to 6.0 wt.-%, of calcium hydroxide.

10. The multi-component composition according to claim 1, wherein the powder component comprises 2 to 8 wt.-%, preferably 4.5 to 6.0 wt.-%, of calcium oxide.

11. The multi-component composition according to claim 1, wherein the powder component comprises 60 to 80 wt.-% of the aggregates, preferably wherein the aggregates comprise sand.

12. The multi-component composition according to claim 1, wherein the polyol component, the polyisocyanate component and the powder component account for 10 to 25 wt.-%, 10 to 25 wt.-% and 50 to 80 wt.-%, respectively, of the combined amount of polyol, polyisocyanate and powder component.

13. The multi-component composition according to claim 1, wherein
the content of water is in the range of 4.5 to 6.5 wt.-%,
the content of the MDI is in the range of from 15 to 17 wt.-%, and
the content of cement is in the range of 16 to 25 wt.-%, based on the total weight of the polyol, polyisocyanate and the powder component.

14. The multi-component composition according to claim 1, wherein the molar ratio of NCO groups to alcoholic OH groups is in the range of 1.5:1 to 3:1, preferably in the range of 2:1 to 2.5:1.

15. Use of an admixture of an amino alcohol and an acid to increase the curing speed of a multi-component composition comprising a polyol, MDI, cement, aggregates, calciumhydroxide and/or calcium oxide, and water.

16. Method for the manufacture of a polyurethane cementitious hybrid flooring or coating with a composition according to claim 1, wherein the method comprises
mixing the polyol component and the polyisocyanate component
adding the powder component and the curing accelerator component to the mixture of polyol component and the polyisocyanate component and agitating the same to obtain a substantially homogeneous mixture
applying the substantially homogeneous mixture to a substrate, and
curing the applied mixture to obtain the cementitious flooring or coating.

17. Flooring or coating, obtainable by the method of claim 16.
